(19) United States
(12) Patent Application Publication
(10) Pub. No.: US 2016/0044194 A1
(43) Pub. Date: Feb. 11, 2016

(54) PRINTING APPARATUS, METHOD OF CONTROLLING THE SAME, AND STORAGE MEDIUM

(71) Applicant: CANON KABUSHIKI KAISHA, Tokyo (JP)

(72) Inventor: Toru Wakana, Nagareyama-shi (JP)

(21) Appl. No.: 14/809,146

(22) Filed: Jul. 24, 2015

(30) Foreign Application Priority Data
Aug. 5, 2014 (JP) 2014-159767

(51) Int. Cl. H04N 1/00

(52) U.S. Cl. CPC H04N 1/00631; H04N 1/0032; H04N 1/00466; H04N 1/00663; H04N 2201/0094

(57) ABSTRACT

A printing apparatus according to the present invention prints onto sheets in accordance with a print job, and includes a stacking unit that receives the printed sheets and stacks the sheets, and that is able to eject the stacked sheets so that an operator can remove the sheets. It is then determined whether or not sheets are stacked on the stacking unit. Control is carried out so that the stacked sheets are ejected when execution of a print job, if a setting for ejecting the stacked sheets each time a number of sheets corresponding to a designated number of copies have been stacked on the stacking unit is made for the print job and it has been determined that sheets are stacked in the stacking unit.

### BACKGROUND OF THE INVENTION

1. Field of the Invention

The present invention relates to a printing apparatus, a method of controlling the same, and a storage medium.

2. Description of the Related Art

Printing apparatuses that print a large amount of sheets based on document data generated by an application and stack the large amount of sheets on a stacking unit of a large-volume stacker are known. Some recent large-volume stackers are capable of continually stacking sheets by switching to another stacking unit when a stacking unit on which sheets are currently being stacked becomes full. Such a stacker is configured so that when the stacking unit on which the sheets are being stacked becomes full, a bundle of sheets stacked on the stacking unit is automatically ejected out of the stacker, and sheets can continue to be stacked on another stacking unit in the stacker.

Meanwhile, in the case where the sheets of a large number of copies are to be stacked on a stacking unit of a large-volume stacker, there is a function that divides the sheets into set units of copies and stacks the sheets in such a state. This technique assumes a workflow in which a bundle of sheets stacked in a divided manner using this function is handled as a single unit, and each unit is then packaged, distributed, and so on (see Japanese Patent Laid-Open No. 2010-277339).

However, in an environment where multiple users use such a large-volume stacker, it is possible that sheets printed based on a previous job remain in the large-volume stacker before another print job is loaded. In such a case, unless the sheets printed in the previous job and already stacked in the large-volume stacker are removed, those sheets will become mixed in with the sheets printed based on the newly-started print job.

Instructing users to remove sheets remaining in the large-volume stacker each time prior to loading a print job is conceivable as a measure against this issue, but making such an instruction each time is cumbersome, and users may forget such instructions. Meanwhile, even if a user has removed sheets remaining in the large-volume stacker, if another print job is started first, sheets printed for the other print job will once again be stacked in the large-volume stacker before the user executes his/her print job. In such a case, there is a risk that the user will not notice that the sheets from the other print job are being intermixed. Furthermore, it is unacceptable for unrelated sheets to be intermixed particularly in the case where the aforementioned function that divides the sheets into set units of copies and stacks the sheets in such a state is used, and it is thus absolutely necessary to instruct the sheets to be removed each time. Accordingly, what is needed is a technique that lightens the burden of removal instructions for users and prevents instructions from being forgotten.

### SUMMARY OF THE INVENTION

An aspect of the present invention is to eliminate the above-mentioned problems with the conventional technology.

The feature of the present invention is to provide a technique that prevents sheets from being intermixed in a stacking unit that holds printed sheets in a stacked state.

According to a first aspect of the present invention, there is provided a printing apparatus comprising: a printing unit that prints onto sheets in accordance with a print job; a stacking unit that receives the sheets printed by the printing unit and stacks the sheets, and that is able to eject the stacked sheets so that an operator can remove the sheets; a determination unit that determines whether or not sheets are stacked on the stacking unit; and a control unit that, when a setting for ejecting the stacked sheets each time a number of sheets corresponding to a designated number of copies have been stacked on the stacking unit is made for a print job and it is determined by the determination unit that sheets are stacked on the stacking unit, carries out control so that the sheets stacked on the stacking unit are ejected when execution of the print job starts.

According to a second aspect of the present invention, there is provided a method for controlling a printing apparatus, the method comprising: printing onto sheets in accordance with a print job; receiving and stacking the sheets printed in the printing, and discharging and stacking the sheets printed in the printing on a stacker capable of ejecting the stacked sheets so that an operator can remove the sheets; determining whether or not sheets are stacked in the stacker; and carrying out control so that, when a setting for ejecting the stacked sheets each time a number of sheets corresponding to a designated number of copies have been stacked on the stacking unit is made for a print job and it is determined in the determining that sheets are stacked in the stacker, the sheets stacked in the stacker are ejected when execution of the print job starts.

Further features of the present invention will become apparent from the following description of an exemplary embodiment (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram illustrating the overall configuration of a printing system according to an embodiment of the present invention.

FIG. 2 depicts a general view of an MFP according to the embodiment.

FIGS. 3A-3C are diagrams for describing the configuration of a stacker according to an embodiment.

FIGS. 4A-4D and FIGS. 5A-5C are diagrams for describing a process from sheets being stacked on a stacker to a bundle of sheets being ejected out of the stacker, according to the embodiment.

FIGS. 6A-6F are diagrams illustrating operations when the stacker according to the embodiment executes stacking of a designated number of copies.

FIGS. 7A-7D are diagrams illustrating bundles of sheets being stacked in the stacker according to the embodiment.

FIG. 8 is a block diagram for describing the configurations of a PC and an MFP in the printing system according to the embodiment.

FIG. 9A is a flowchart for describing the flow of an overall process carried out by the printing system according to the embodiment.

FIG. 9B is a flowchart for describing processing of generating a print job carried out in step S901.

FIG. 10A is a flowchart for describing an overview of processing carried out in step S902 of FIG. 9A.

FIG. 10B is a flowchart for describing page generation processing carried out in step S1000 of FIG. 10A.

FIG. 11 is a flowchart for describing printing processing carried out in step S1001 of FIG. 10A.

FIG. 12 is a flowchart for describing discharge processing 1 carried out in step S1101 of FIG. 11.

FIG. 13 is a flowchart for describing ejecting processing carried out in step S1102 of FIG. 11.

FIG. 14 is a flowchart for describing discharge processing 2 carried out in step S1103 of FIG. 11.

FIG. 15 is a flowchart for describing processing for discharging to a stacker carried out in step S1207 of FIG. 12 and step S1410 of FIG. 14.

FIG. 16 is a diagram illustrating an example of a UI screen displayed by a printer driver in the PC according to the embodiment.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

FIG. 1 is a diagram illustrating the overall configuration of a printing system according to an embodiment of the present invention.

A PC 101 is an external device such as a host computer that creates document data by executing a given application or the like, creates print data using a printer driver, and supplies the print data to a multifunction peripheral (MFP) 102 over a network 103. The MFP 102 is a multi-function peripheral having a scan function, a print function, a send function, a box function, a facsimile function, and so on.

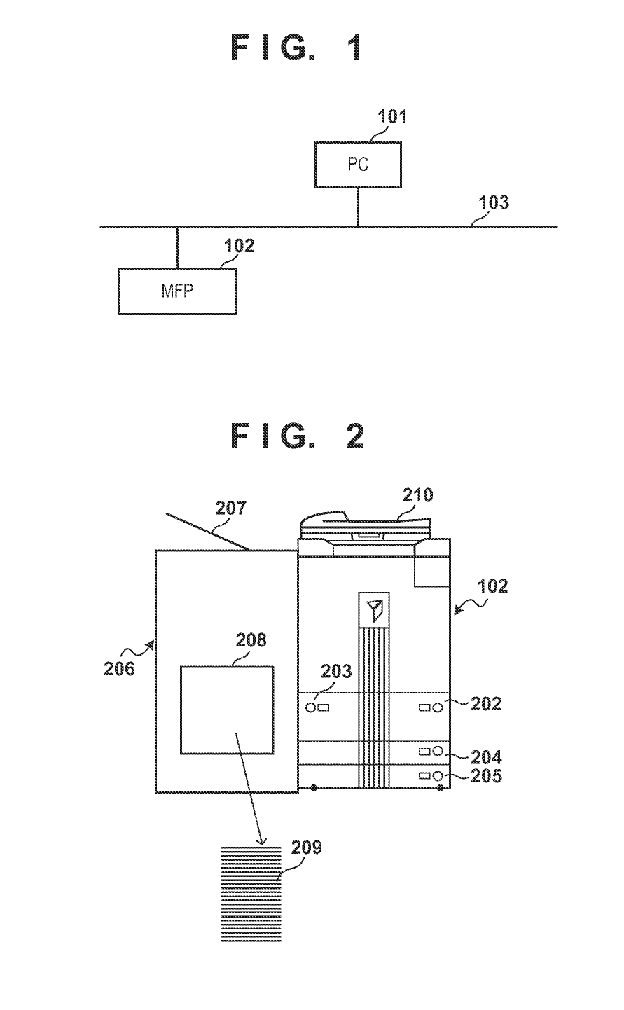

FIG. 2 is a general view of the MFP 102 according to the present embodiment.

The MFP 102 is connected to a stacker 206 that receives sheets printed and discharged by the MFP 102 and holds the sheets in a stacked state. The MFP 102 has paper feed decks 202-205, each of which holds sheets to be printed onto by the MFP 102 in a stacked state.

A sampling tray 207 of the stacker 206 is used in the case where sheets printed by the MFP 102 and discharged to the stacker 206 are to be extracted. A stacking unit 208 of the stacker 206 can hold, in a stacked state, a large amount of sheets printed by the MFP 102. Numeral 209 denotes a bundle of sheets that have been discharged and stacked in the stacking unit 208. A scanner 210 is provided in the MFP 102, and conveys and reads a document placed in an auto document feeder (ADF), and outputs image data of the document.

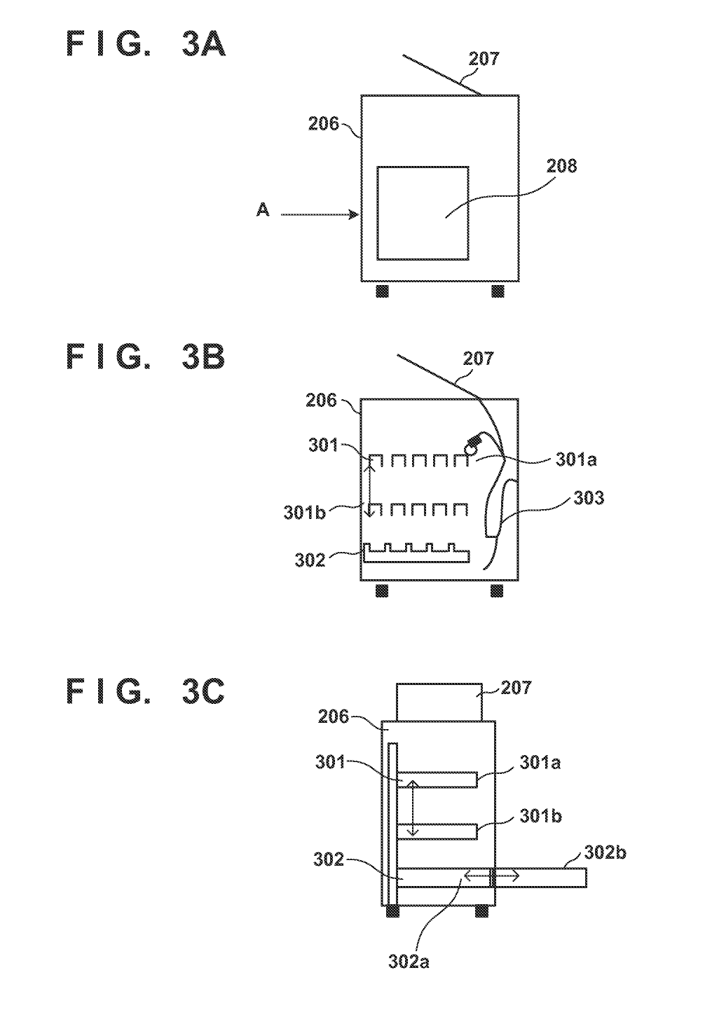

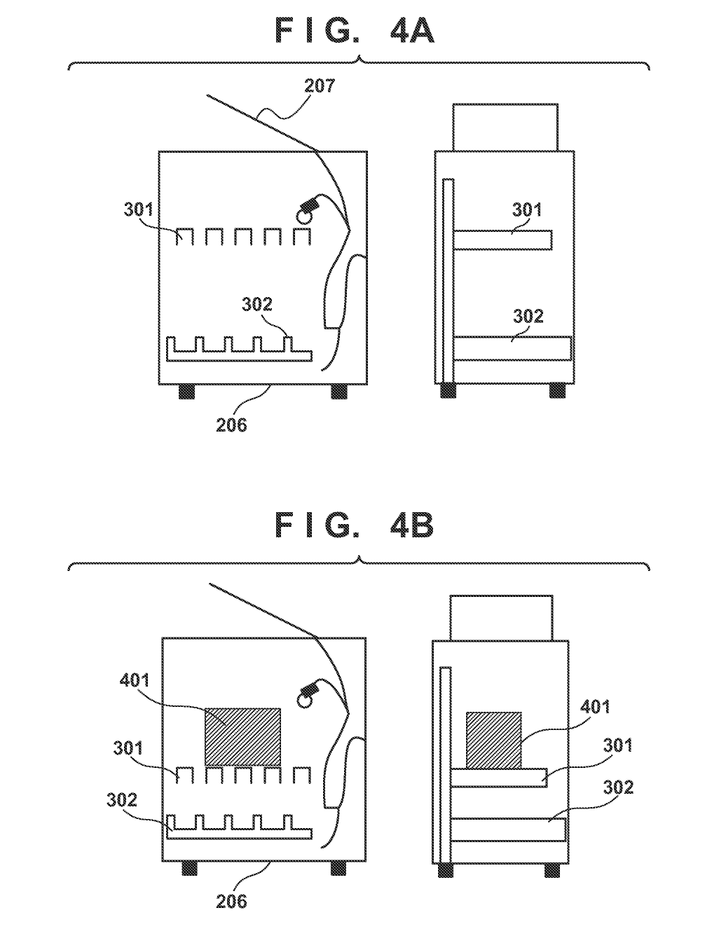

Next, operations of the stacker 206 according to the embodiment will be described with reference to FIGS. 3A to 5C.

FIGS. 3A to 3C are diagrams for describing the configuration of the stacker 206 according to the embodiment, where FIG. 3A depicts a front view of the stacker 206, FIG. 3B is a cross-sectional view taken from the front of the stacker 206, and FIG. 3C is a cross-sectional view taken from an arrow A indicated in FIG. 3A. In FIGS. 3A to 3C, portions that are the same as in the aforementioned FIG. 2 are given the same reference numerals.

As illustrated in FIG. 3B, a lift table 301 receives and holds sheets discharged from the MFP 102, and is capable of up-down movement. Note that although there is actually only one lift table 301, the lift table 301 is capable of up-down movement, and thus a state where the lift table 301 is at its uppermost position is indicated by 301a and a state where the lift table 301 is at its lowermost position is indicated by 301b. An eject table 302 can receive a bundle of sheets stacked on the lift table 301 and eject the bundle outside of the stacker 206. Note that although there is actually only one eject table 302, the eject table 302 is capable of left-right movement as indicated in FIG. 3C, and thus 302b in FIG. 3C indicates a state where the eject table 302 is outside of the stacker 206 (ejected) and 302a indicates a state where the eject table 302 is within the stacker 206. In FIG. 3B, a sheet conveyance path 303 indicates a conveyance path along which sheets discharged from the MFP 102 are conveyed in the stacker 206. Note that in the present embodiment, the lift table 301 and the eject table 302 will be referred to collectively as the stacking unit 208 of the stacker 206 unless otherwise specified.

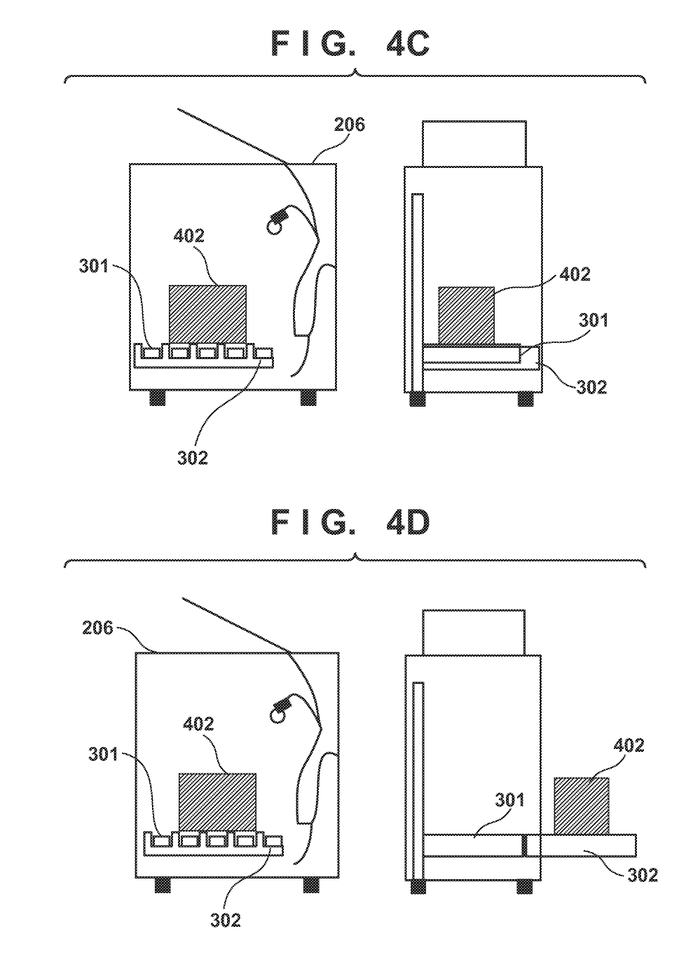

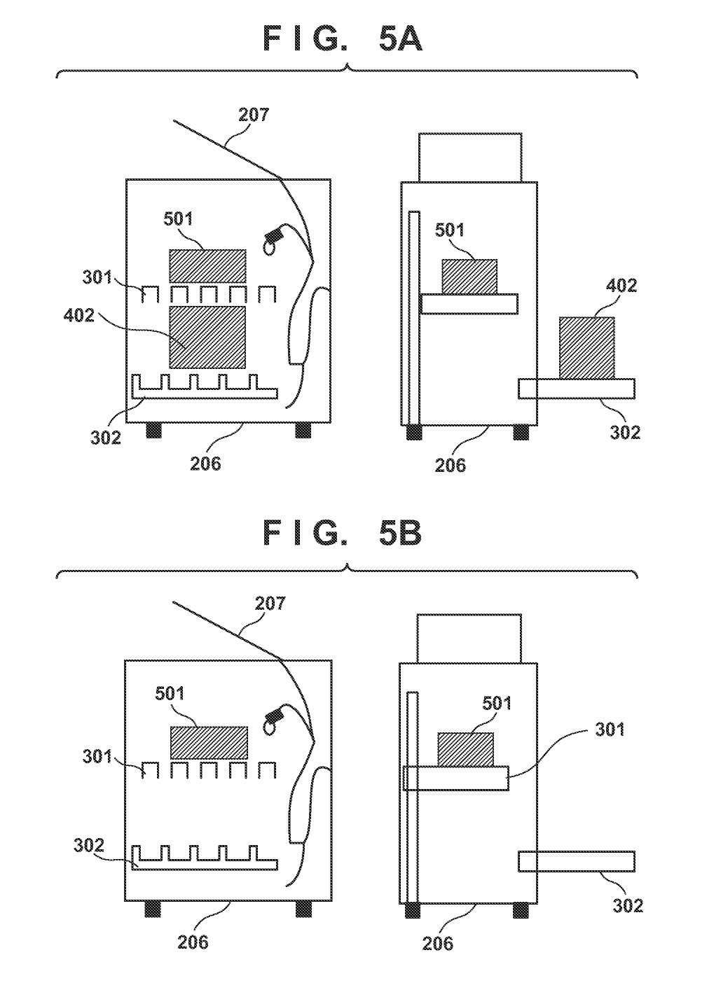

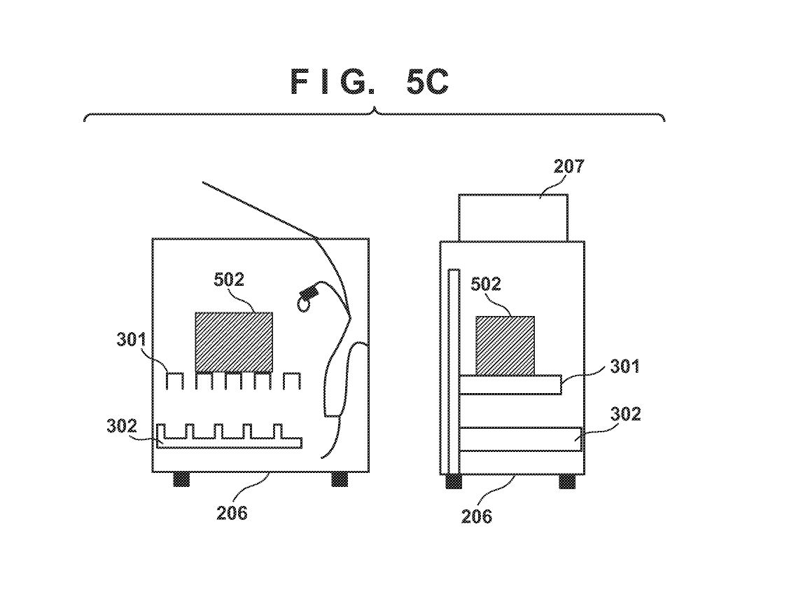

FIGS. 4A-4D and FIGS. 5A-5C are diagrams for describing a process from sheets being stacked on the stacker 206 to a bundle of sheets being ejected out of the stacker 206, according to the embodiment. Note that in FIGS. 4A to 4D and 5A to 5C, the left sides are cross-sectional views taken from the front of the stacker 206, corresponding to FIG. 3B, whereas the right sides are cross-sectional views corresponding to FIG. 3C, taken from the arrow A in FIG. 3A. In FIGS. 4A to 5C, portions that are the same as in the aforementioned FIGS. 3A to 3C are given the same reference numerals.

FIG. 4A depicts a view illustrating a state in which sheets are not stacked in the stacking unit 208 (on the lift table 301 and the eject table 302) of the stacker 206, and in this state, the lift table 301 and the eject table 302 are in their original positions.

FIG. 4B depicts a view illustrating a state in which a bundle of sheets 401 is stacked on the lift table 301. In this state, the lift table 301 descends below the position illustrated in FIG. 4A in accordance with the amount of sheets that are stacked.

FIG. 4C depicts a view illustrating a state in which the amount of sheets stacked on the lift table 301 has reached a maximum and the stacking unit 208 has become full. This state is a state in which the lift table 301 has descended and a bundle of sheets 402 is stacked on the eject table 302. This is carried out in the case where it has been determined that the lift table 301 is full using a full load sensor (not shown) of the lift table 301.

FIG. 4D depicts a view illustrating a state in which the bundle of sheets 402 stacked on the eject table 302 has been ejected outside of the stacker 206 as a result of the eject table 302 moving outside of the stacker 206. At this time, the lift table 301 remains in a descended state.

FIG. 5A depicts a view illustrating a state following the bundle of sheets 402 stacked on the eject table 302 being ejected as illustrated in FIG. 4D, where the lift table 301 has ascended and sheets discharged from the MFP 102 are once again stacked on the lift table 301. Here, a bundle of sheets 501 indicates the next bundle of sheets stacked on the lift table 301.

FIG. 5B depicts a view illustrating a state in which an operator (not shown) has manually removed the bundle of sheets 402 from upon the eject table 302, from the state illustrated in FIG. 5A. In other words, this is a state in which no sheets are stacked on the eject table 302.

FIG. 5C depicts a view illustrating a state in which the eject table 302 is withdrawn into the stacker 206 as a result of a sensor (not shown) provided in the eject table 302 detecting that no sheets are stacked on the eject table 302 as illustrated in FIG. 5B. FIG. 5C also depicts a state in which sheets continue to be stacked on the lift table 301. A bundle of sheets 502 indicates a bundle of sheets stacked on the lift table 301.

Printed sheets can be continuously discharged from the MFP 102 and stacked in the stacker 206 by repeating operations such as those illustrated in the aforementioned FIGS. 4A to 5C.

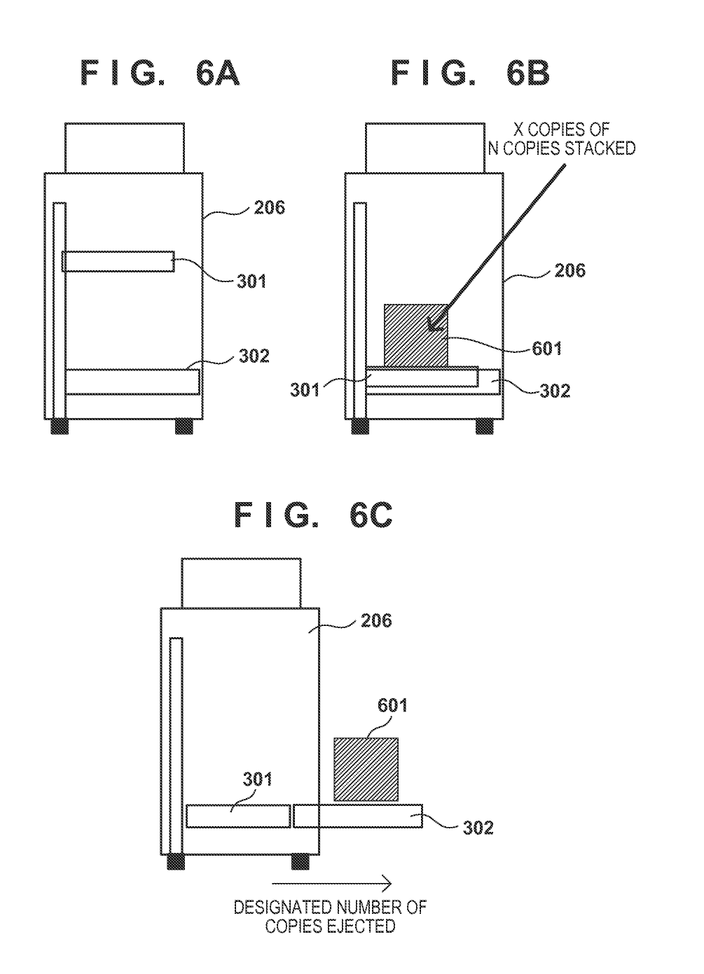

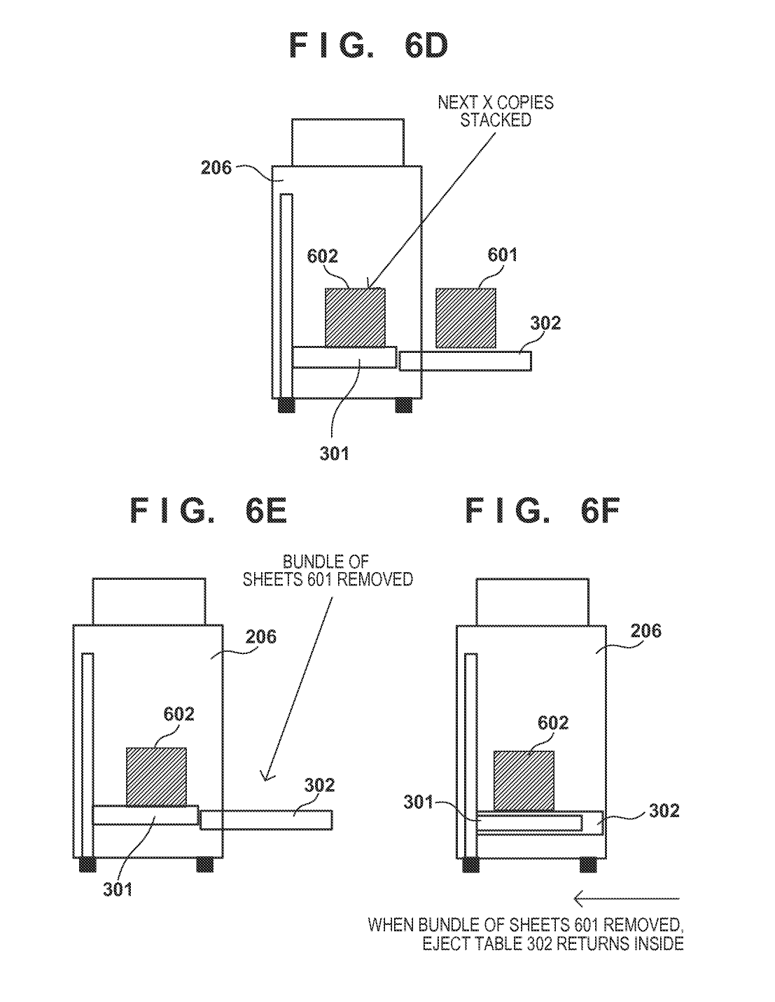

Next, operations carried out when the stacker 206 according to the embodiment executes stacking of a designated number of copies will be described with reference to FIGS. 6A to 6F. “Stacking of a designated number of copies” refers to a function for stacking bundles of sheets corresponding to a designated number of copies as a single bundle of sheets. For example, in the case where a total number of copies is 10,000 copies and the stacking of a designated number of copies is set to 1,000 copies, bundles of sheets corresponding to the 1,000 copies are stacked in the stacking unit 208 of the stacker 206 as a single bundle. A total of 10 bundles of sheets (where each bundle of sheet is constituted by 1,000 copies) are produced as a result.

FIGS. 6A-6F depict cross-sectional views illustrating operations when the stacker 206 according to the embodiment executes the stacking of a designated number of copies. These cross-sectional views are taken from the arrow A indicated in FIG. 3A. These diagrams illustrate a case in which the designated number of copies is N copies and the stacking of the designated number of copies is set to X copies (where N>X). In other words, here, bundles of sheets corresponding to X copies are stacked in the stacking unit 208 as a single bundle of sheets, and a total of N bundles of sheets are produced. In FIGS. 6A to 6F, portions that are the same as in the aforementioned FIGS. 3A to 3C are given the same reference numerals.

FIG. 6A depicts a view illustrating a state in which no sheets are stacked on the stacking unit (lift table 301) 208 of the stacker 206.

FIG. 6B depicts a view illustrating a state in which X copies of sheets 601 among the N copies have been stacked on the lift table 301 in the stacking unit (lift table 301) 208.

FIG. 6C depicts a view illustrating a state in which a bundle of sheets 601 corresponding to X copies has been stacked, and thus the designated number of copies has been instructed to be ejected, resulting in the eject table 302 being ejected out of the stacker 206 with the bundle of sheets 601 stacked thereon. Here, no sheets are stacked on the lift table 301.

FIG. 6D depicts a view illustrating a state in which the lift table 301 has returned to an uppermost position from the state illustrated in FIG. 6C, after which sheets discharged from the MFP 102 have been stacked on the lift table 301 and a bundle of sheets 602 corresponding to the next X copies has been stacked on the lift table 301. In other words, FIG. 6D illustrates a state in which a bundle of sheets corresponding to the next X copies has been stacked on the lift table 301.

FIG. 6E depicts a view illustrating a state in which the operator (not shown) has manually removed the bundle of sheets 601 that was stacked on the eject table 302, from the state illustrated in FIG. 6D.

FIG. 6F depicts a view illustrating a state in which the eject table 302 has returned to the interior of the stacker, from the state illustrated in FIG. 6E. This is an operation carried out in the case where the sensor (not shown) provided in the eject table 302 has detected that a bundle of sheets is not stacked on the eject table 302 in the state illustrated in FIG. 6E. In FIG. 6F, the bundle of sheets 602 that was stacked on the lift table 301 moves onto the eject table 302. The bundle of sheets 602 corresponding to the next X copies is ejected out of the device as a result of the eject table 302 being ejected out of the stacker 206 from this state, as illustrated in FIG. 6C.

By repeating the operations illustrated in FIGS. 6C to 6F, the stacker 206 can carry out the stacking of a designated number of copies that ejects a bundle of sheets as a bundle of sheets corresponding to X copies.

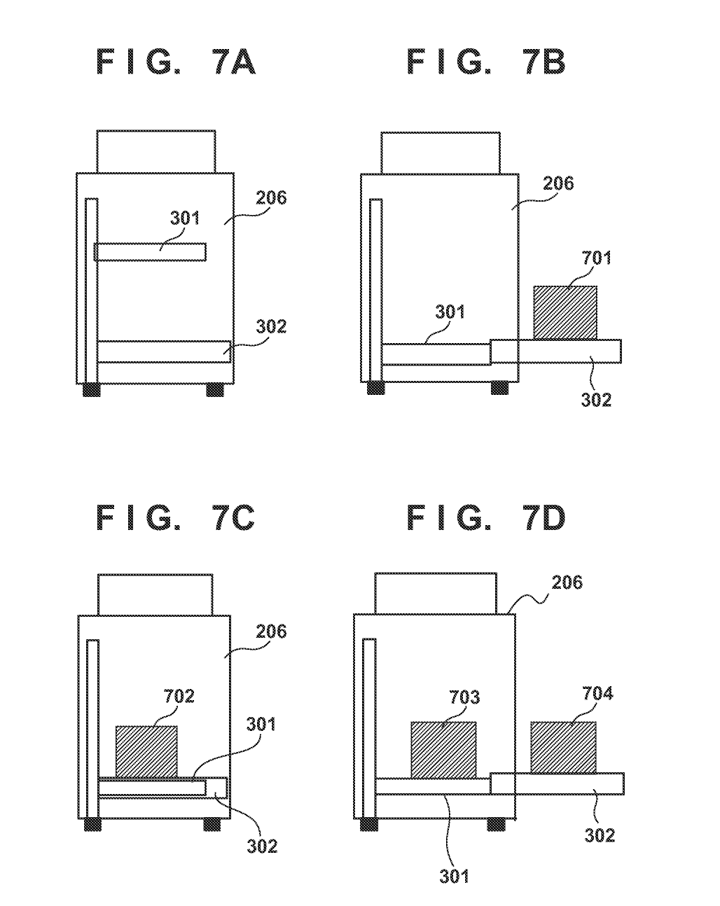

FIGS. 7A-7D are diagrams illustrating bundles of sheets being stacked in the stacker 206 according to the embodiment. These cross-sectional views are also taken from the arrow A indicated in FIG. 3A. In FIGS. 7A to 7D, portions that are the same as in the aforementioned FIGS. 3A to 3C are given the same reference numerals.

FIG. 7A depicts a view illustrating a state in which no sheets are stacked on the lift table 301 and the eject table 302 in the stacking unit of the stacker 206.

FIG. 7B depicts a view illustrating a state in which a bundle of sheets 701 is stacked on the eject table 302 of the stacker 206 and has been ejected outside of the stacker 206. Here, the lift table 301 remains in a descended state. After this, the lift table 301 once again returns to its uppermost position, and can thus receive and stack sheets discharged from the MFP 102.

FIG. 7C depicts a view illustrating a state in which a bundle of sheets 702 is stacked on the eject table 302. Ejecting the eject table 302 outside of the stacker 206 from this state results in a state in which no sheets are stacked on the lift table 301. Then, when the lift table 301 is once again returned to its uppermost position, the lift table 301 can receive and stack sheets discharged from the MFP 102.

FIG. 7D depicts a view illustrating a state in which bundles of sheets 703 and 704 are stacked on the lift table 301 and the eject table 302, respectively. In this state, sheets discharged from the MFP 102 cannot be received and stacked unless the bundle of sheets 704 is removed from the eject table 302.

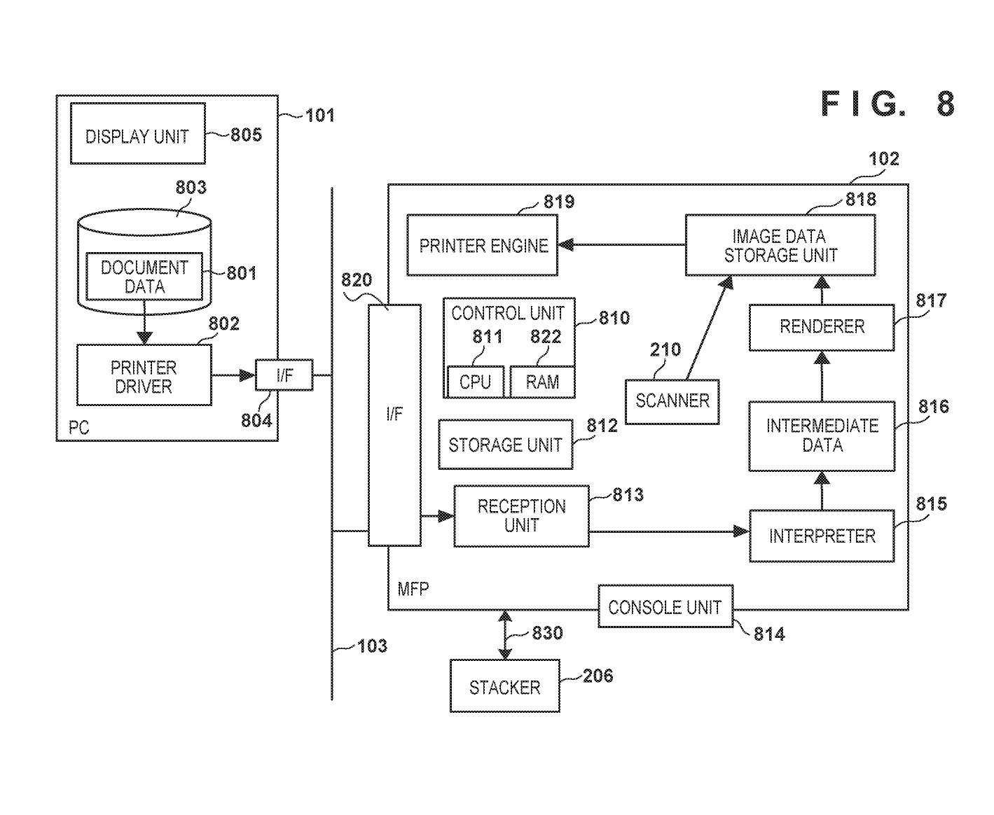

FIG. 8 is a block diagram for describing the configurations of the PC 101 and the MFP 102 in the printing system according to the embodiment.

Document data 801 is document data stored in the PC 101. “Document data” as used here refers to data created using a given word processing application (not shown). A printer driver 802 generates PDL (Page Description Language) data from the document data 801. “PDL” as used here is assumed to be page description language such as PS, PCL, LIPS, or the like, for example. Of course, another page description language may be used instead. A storage unit 803 is an HDD (hard disk drive), for example, and stores the document data 801, the printer driver 802, the application (not shown) used to create the document data 801, and so on. A communication interface 804 transmits the PDL data (not shown) created by the printer driver 802 over the network 103. A display unit 805 has touch panel functionality, and displays a print settings screen created by the printer driver 802, such as that illustrated in FIG. 16, for example.

Next, the configuration of the MFP 102 according to the embodiment will be described.

A control unit 810 has a CPU 811, a RAM 822, and the like, and controls operations performed by the MFP 102. The CPU 811 controls operations of the MFP 102 by deploying programs stored in a storage unit 812 into the RAM 822 and executing those programs. A communication interface 820 receives the PDL data (not shown) and so on transmitted from the PC 101 over the network 103. A reception unit 813 holds the PDL data (not shown) received through the communication interface 820. An interpreter 815 analyzes the PDL data (not shown) received by the reception unit 813. Note that the interpreter 815 is assumed to be capable of analyzing PDL formats such as the aforementioned PS, PCL, LIPS, and so on. Of course, formats aside from those mentioned here may be used instead. Intermediate data 816 is data generated by the interpreter 815 analyzing and converting the PDL data (not shown) received by the reception unit 813. A renderer 817 analyzes the intermediate data 816 and converts that data into image data (not shown). An image data storage unit 818 stores the image data (not shown) obtained as a result of the processing performed by the renderer 817. Although the functions of the reception unit 813, the interpreter 815, and the renderer 817 are realized by the CPU 811 executing the aforementioned programs in the present embodiment, it should be noted that these units may be realized by respective individual ICs or the like.

A printer engine 819 receives and prints data converted into a video signal (not shown) from the image data (not shown) stored in the image data storage unit 818. The scanner 210 reads a document (not shown) and generates image data corresponding to an image of the document. Note that image data generated by the scanner 210 is stored in the image data storage unit 818 as the image data (not shown). The storage unit 812 is also capable of saving a control program of the MFP 102, image data stored in the image data storage unit 818, and so on, and is furthermore used to save various types of print setting information (not shown). A console unit 814 includes display unit having touch panel functionality, keys manipulated by users, and the like.

The printed sheets discharged from the MFP 102 are conveyed to the stacker 206 and stacked in the stacking unit 208. Here, the stacker 206 and the MFP 102 are connected by a control line 830, and the CPU 811 of the control unit 810 can grasp the stacking state of sheets in the stacking unit 208 through this control line 830. The CPU 811 can also control the up-down movement of the lift table 301, ejection operations of the eject table 302, and so on through the control line 830.

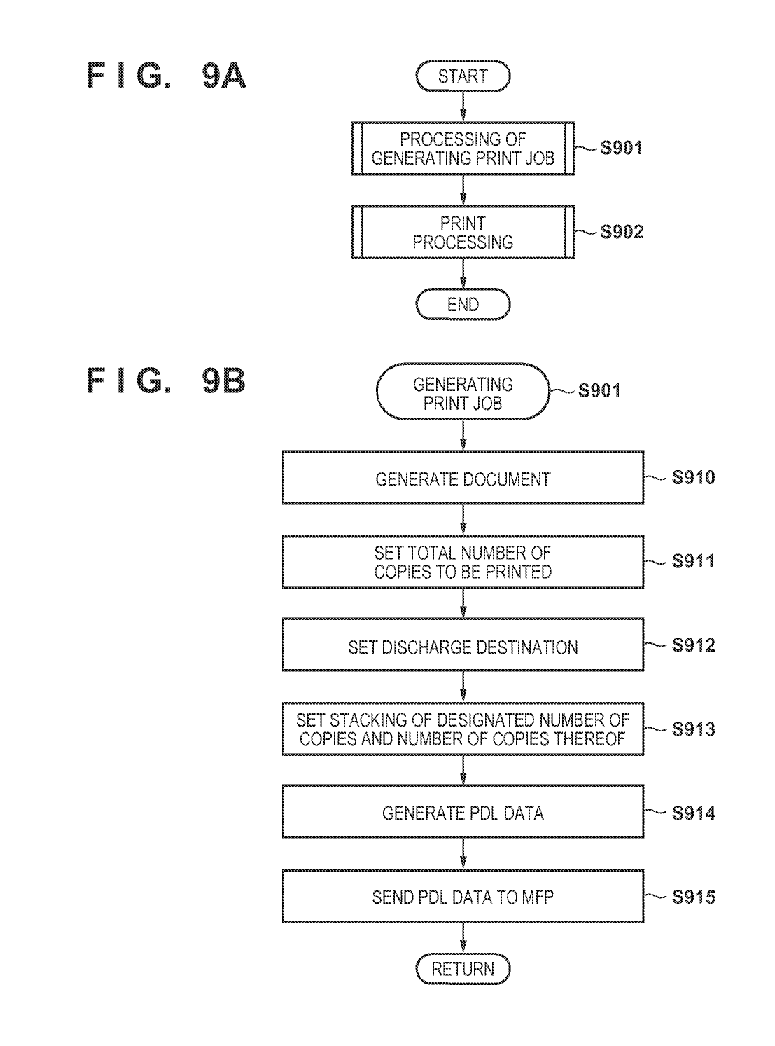

Next, the present embodiment will be described using the flowcharts of FIG. 9A and on.

FIG. 9A is a flowchart for describing a flow of an overall process carried out by the printing system according to the embodiment. In this printing system, the PC 101 and the MFP 102 are connected over the network 103 as illustrated in FIG. 1, and the MFP 102 prints in response to the PC 101 transmitting PDL data to the MFP 102 through the printer driver 802.

Step S901 is a process of generating a print job, carried out by the printer driver 802 of the PC 101. In step S901, an operator of the PC 101 generates the document data 801 by executing a given word processing application in the PC 101. The printer driver 802 then generates the PDL data (not shown) from the document data 801. Furthermore, the printer driver 802 makes various types of settings used when printing the document data 801, and transmits the PDL data to the MFP 102 over the network 103. Note that the processing carried out by the printer driver 802 in step S901 will be described in detail using the flowchart illustrated in FIG. 9B.

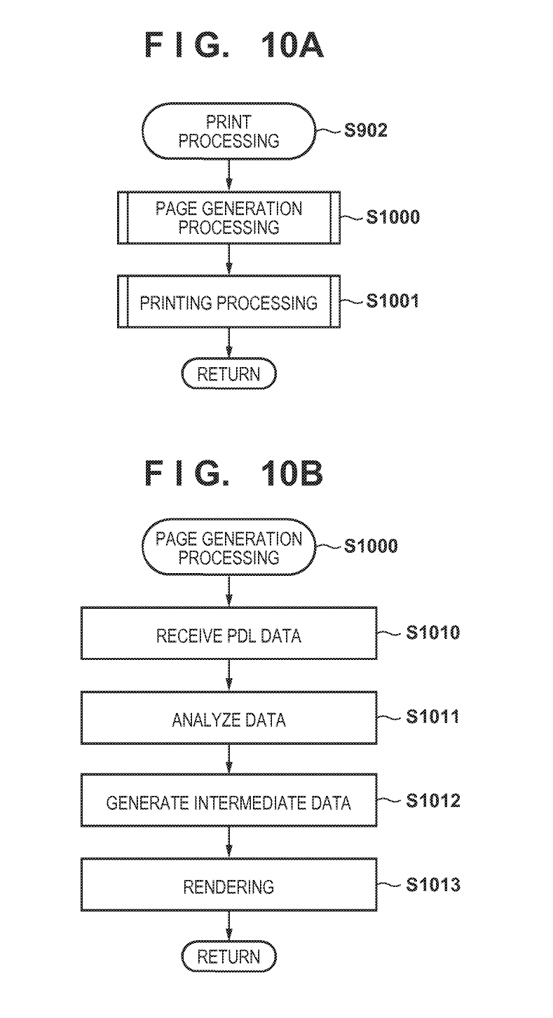

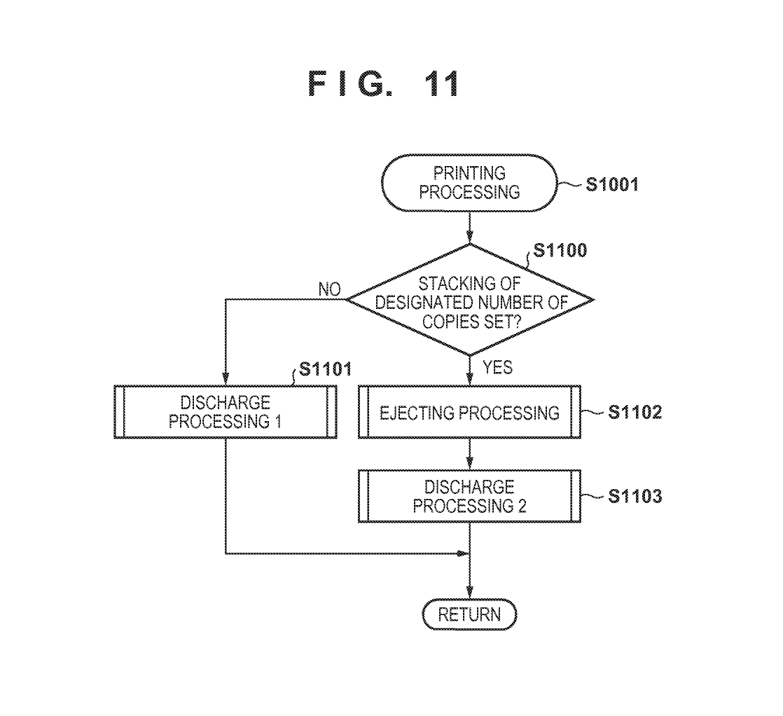

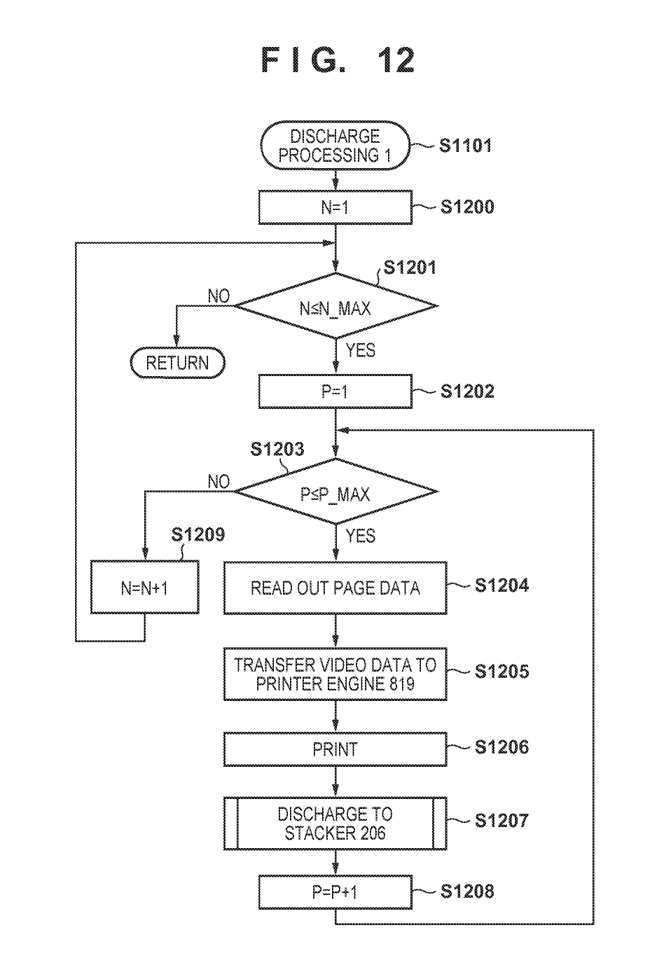

The processing then advances to step S902, where the MFP 102 receives the print job transmitted from the PC 101 and executes printer processing. In this processing, the control unit 810 receives the PDL data and converts the PDL data into image data. The control unit 810 then converts the image data into a video signal, outputs the signal to the printer engine 819, and executes the print. Furthermore, the control unit 810 discharges printed sheets to the stacker 206 in accordance with settings in the printer driver 802. Note that the printer processing of step S902 will be described in detail with reference to the flowchart illustrated in FIG. 10A.

Next, processing of generating a print job performed in step S901 of FIG. 9A will be described with reference to the flowchart illustrated in FIG. 9B.

However, a UI screen of the printer driver, illustrated in FIG. 16, will be described first.

FIG. 16 is a diagram illustrating an example of a UI screen displayed by the printer driver 802 on the display unit 805 of the PC 101 according to the embodiment.

A tab 1601 indicates that this UI screen is a “print settings” screen. A total number of copies setting field 1602 is used to set a total number of copies to be printed. In this example, “10,000 copies” is set. Note that the set value can be increased and decreased by manipulating the up and down arrows on the right side of the total number of copies setting field 1602. A paper size setting field 1603 is used to set a paper size to be used in the printing. In this example, “A4” size is set. Note that the paper size can be changed by manipulating the up and down arrows on the right side of the paper size setting field 1603. A discharge destination field 1604 is used to designate where the sheets printed by the MFP 102 will be discharged to. In this example, “stacker 1” (the stacker 206) is set. Note that other discharge destinations can be set by manipulating the up and down arrows on the right side of the setting field 1604. Radio buttons 1605 are used to set whether the aforementioned stacking of a designated number of copies is active or inactive. In this example, “ON” (stacking of a designated number of copies is active) is selected. A setting field 1606 is a setting field for setting a number of copies in the stacking of a designated number of copies. In this example, “1,000 copies” is set. This makes it possible to designate a final product (stacked product) in which 1,000 copies are taken as a single bundle of sheets to be produced. Note that the set value can be increased and decreased by manipulating the up and down arrows on the right side of the setting field 1606. Based on the settings in this screen, A4-size sheets will be conveyed to and stacked on the stacking unit 208 of the stacker 206, for a total of 10 bundles of sheets in which a single bundle has 1,000 copies.

Returning to FIG. 9B, the processing of generating a print job will be described.

First, in step S910, an operator executes an application in the PC 101 and generates the document data 801. Next, the processing advances to step S911, where the operator sets a total number of copies to be printed in the UI screen illustrated in FIG. 16. In the example illustrated in FIG. 16, “10,000 copies” is set. Accordingly, sheets for 10,000 copies are printed. Next, the processing advances to step S912, where the operator sets a discharge destination in the UI screen illustrated in FIG. 16, setting the stacker 206 as the discharge destination. As a result, the sheets printed by the MFP 102 are conveyed to the stacker 206 and stacked. Next, the processing advances to step S913, where the operator selects the radio button ON, for activating the stacking of a designated number of copies, in the UI screen illustrated in FIG. 16. The operator also sets the number of copies for the stacking of a designated number of copies in the UI screen. In the example illustrated in FIG. 16, “1,000 copies” is set. This makes it possible to generate a final product (stacked product) in which 1,000 copies are taken as a single bundle. Next, the processing advances to step S914, where the printer driver 802 converts the document data 801 into PDL data; the PDL data is then transmitted to the MFP 102 in step S915. Note that at this time, the printer driver 802 adds the number of copies designated in step S911, the discharge destination designated in step S912, the setting of the stacking of a designated number of copies designated in step S913, and the number of copies for the stacking of a designated number of copies to the PDL data, and transmits the PDL data in that state.

Next, printer processing carried out by the MFP 102 according to the embodiment will be described with reference to FIGS. 10A, 10B, and 11.

FIG. 10A is a flowchart for describing an overview of print processing carried out in step S902 of FIG. 9A. Note that the programs that execute this processing are stored in the storage unit 812; when the programs are to be executed, the programs are deployed into the RAM 822 by the CPU 811 and executed under the control of the CPU 811.

When the printer processing is started, first, in step S1000, the CPU 811 carries out page generation processing. In this page generation processing, the PDL data received from the PC 101 is converted into image data. The page generation processing will be described in detail later with reference to the flowchart illustrated in FIG. 10B. Next, the processing advances to step S1001, where the CPU 811 carries out printing processing. In the printing processing, the image data generated in step S1000 is converted into video data, transferred to the printer engine 819, and printed. The printing processing will be described in detail later with reference to the flowchart illustrated in FIG. 11.

FIG. 10B is a flowchart for describing the page generation processing carried out in step S1000 of FIG. 10A.

First, in step S1010, the CPU 811 receives the PDL data transmitted from the PC 101. Next, the processing advances to step S1011, where the CPU 811 analyzes the received PDL data. This corresponds to the function of the interpreter 815. Next, in step S1012, the CPU 811 converts the print data analyzed by the interpreter 815 into the intermediate data 816. This intermediate data 816 is assumed to collectively indicate rendering objects and background patterns such as “bitmap”, “run-length”, “trapezoid”, “box”, and “fast boundary encoding bitmap”, as well as rendering logic used when rendering those objects in a raster memory. At this time, in the case where the settings of the number of copies, the discharge destination, and the stacking of a designated number of copies and information setting the number of copies thereof have been added to the PDL data, the CPU 811 stores those settings in the storage unit 812. The processing then advances to step S1013, where the CPU 811 renders the intermediate data 816. This corresponds to the function of the renderer 817. This “rendering” refers to converting the intermediate data 816 into image data using the renderer 817 and storing the image data in the image data storage unit 818.

FIG. 11 is a flowchart for describing the printing processing carried out in step S1001 of FIG. 10A.

First, in step S1100, the CPU 811 refers to the information stored in the storage unit 812 and determines whether or not a designated number of copies (X) is set for the stacking of a designated number of copies. In the case where the value (X) read out from the storage unit 812 is 0, the CPU 811 determines that the stacking of a designated number of copies is not set, executes discharge processing 1 indicated in step S1101, and ends this processing. The discharge processing 1 in step S1101 is processing in which sheets are printed and the printed sheets are discharged to the stacker 206 and stacked on the stacking unit 208. The discharge processing 1 will be described in detail later with reference to the flowchart illustrated in FIG. 12.

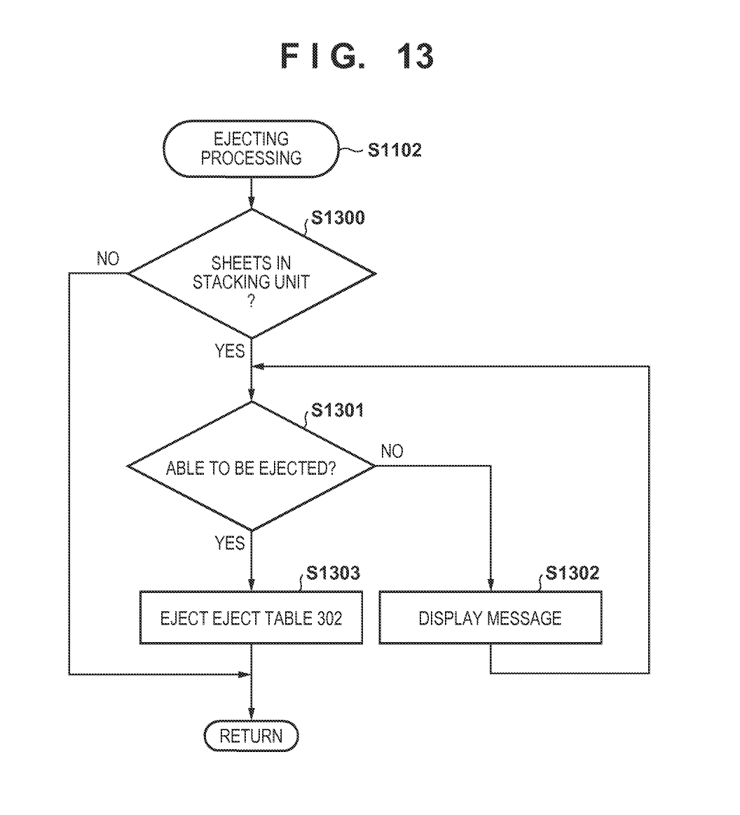

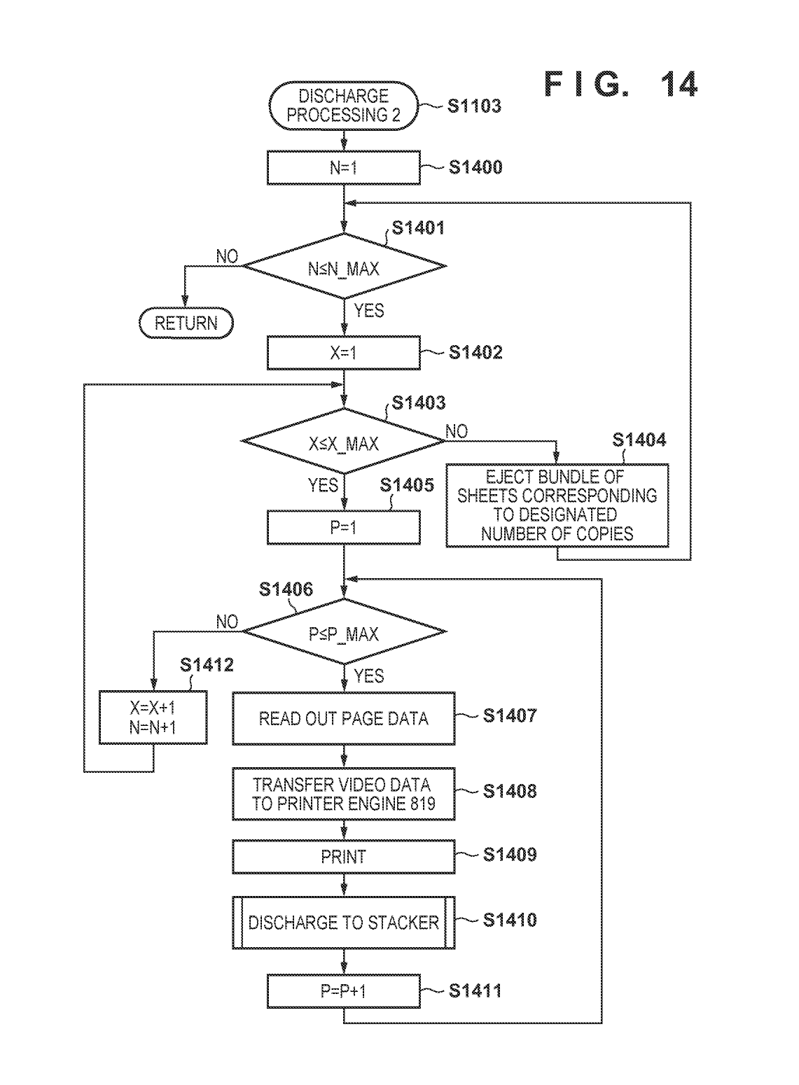

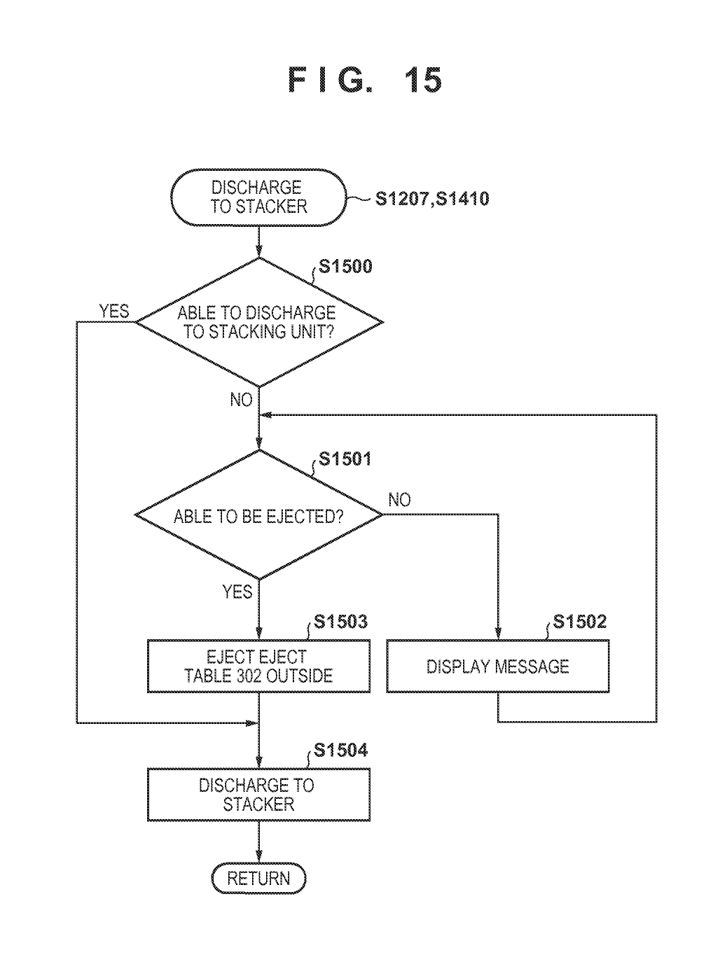

On the other hand, in the case where the value (X) read out from the storage unit 812 in step S1100 is not 0, the CPU 811 determines that the stacking of a designated number of copies is set, advances the processing to step S1102, and executes ejecting processing. In this ejecting processing, the CPU 811 determines whether or not sheets are already present on the lift table 301 in the stacking unit 208 of the stacker 206. In the case where a result of the determination indicates that sheets are already present on the lift table 301, a process for moving those sheets to the eject table 302 and ejecting the sheets out of the stacker 206 is carried out. This is done to prevent the sheets involved in the stacking of a designated number of copies from being mixed in with sheets stacked through a previous job. The ejecting processing will be described in detail later with reference to the flowchart illustrated in FIG. 13. Next, the processing advances to step S1103, where the CPU 811 carries out discharge processing 2. In this processing, the CPU 811 executes processing for discharging the printed sheets to the stacker 206 for each designated number of copies, and then ends this processing. The discharge processing 2 will be described in detail later with reference to the flowchart illustrated in FIG. 14.

Although in the flowchart illustrated in FIG. 11, the ejecting processing is executed in step S1102 in the case where the stacking of a designated number of copies is not specified, the present invention is not limited thereto. That is, step S1102 may be executed in order to remove sheets printed through another job even in the case of a normal print job in which the stacking of a designated number of copies is not designated.

FIG. 12 is a flowchart for describing the discharge processing 1 carried out in step S1101 of FIG. 11.

First, in step S1200, the CPU 811 resets the variable N, which indicates the number of copies being processed, to 1. Note that N is an integer greater than or equal to 1. The variable N is stored in the RAM 822. Next, the processing advances to step S1201, where the CPU 811 determines whether or not the variable N is less than or equal to a total number of copies (N_MAX). This processing ends in the case where the variable N is greater than N_MAX; however, in the case where the variable N is less than or equal to the total number of copies (N_MAX), it is determined that the printing processing is not complete for all of the copies, and the processing advances to step S1202.

In step S1202, the CPU 811 resets a variable P, which indicates a number of pages being processed, to 1. Note that P is an integer greater than or equal to 1. The variable P is also stored in the RAM 822. Next, the processing advances to step S1203, where the CPU 811 determines whether or not the variable P is greater than a total number of pages (P_MAX) in a single copy (that is, a total number of pages included in the received print job). In the case where the variable P is less than or equal to P_MAX, it is determined that there are still pages to be printed, and the processing advances to step S1204; however, in the case where the variable P is greater than P_MAX, it is determined that the processing of a single copy is complete, and the processing advances to step S1209. In step S1209, the CPU 811 adds 1 to the variable N, and the processing returns to step S1201.

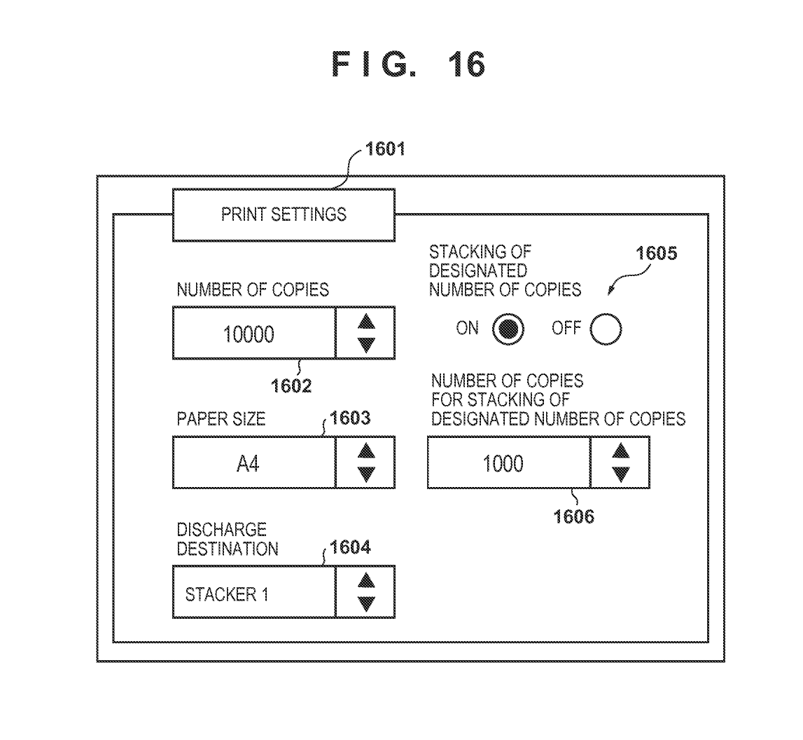

In step S1204, the CPU 811 reads out the image data of a page (P) being processed from the image data storage unit 818, and advances the processing to step S1205. In step S1205, the CPU 811 converts the image data into video data and outputs the video data to the printer engine 819. The processing then advances to step S1206, where the CPU 811 feeds sheets from a paper feed tray of the MFP 102 and causes the printer engine 819 to print onto those sheets using the video data. The processing then advances to step S1207, where the CPU 811 discharges the printed sheets to the stacker 206. The processing for discharging to the stacker 206 will be described in detail later with reference to FIG. 15. Next, the processing advances to step S1208, where the CPU 811 adds 1 to the variable P, and the processing returns to step S1203.

Note that the total number of copies (N_MAX) is 10,000 in the example illustrated in FIG. 16, described earlier. Meanwhile, the total number of pages (P_MAX) is the total number of pages in the image data contained in the received print job, and both of these are stored in the RAM 822.

According to the processing indicated in FIG. 12, a known printing and discharge process, in which only a designated number of copies of the pages in the received print job are printed and discharged to the stacker 206, is executed.

Next, the ejecting processing carried out in step S1102 in FIG. 11 will be described with reference to FIG. 13.

FIG. 13 is a flowchart for describing the ejecting processing carried out in step S1102 of FIG. 11.

First, in step S1300, the CPU 811 determines whether or not sheets are stacked on the stacking unit 208 based on a signal from a stacking sensor provided in the stacker 206. This is done because the stacking of a designated number of copies will not be correctly executed if sheets printed through a job previous to the current print job being executed (a job that carries out the stacking of a designated number of copies) remain in the stacking unit 208. For example, the CPU 811 determines that sheets are not stacked on the stacking unit 208 in the case where the state of sheets stacked on the stacker 206 is the state illustrated in FIG. 7A or 7B. In this case, the CPU 811 determines that the ejecting processing is not necessary, and the processing ends. On the other hand, in the case where the state is the state illustrated in FIG. 7C or 7D, the sheets printed through the current print job will be mixed with the sheets printed through the previous job if the current print job is executed as-is. Accordingly, in this case, the CPU 811 determines that the ejecting processing is necessary, and advances the processing to step S1301.

In step S1301, the CPU 811 determines whether or not the stacking unit 208 of the stacker 206 is in a state in which ejecting operations can be carried out. In the case where the state of the stacking unit 208 is the state illustrated in FIG. 7D, it is determined that the ejecting operations cannot be carried out, and the processing advances to step S1302. In step S1302, the CPU 811 displays an error message on the console unit 814 and ends this processing. Specifically, in step S1302, the CPU 811 notifies the user that it is necessary to remove sheets from the eject table 302 in the stacking unit 208 of the stacker 206 by displaying a predetermined message to that effect in the display unit of the console unit 814. In this case, when the operator removes the sheets from the eject table 302, the state of the stacking unit 208 transits to the state illustrated in FIG. 7C. Through this, the sheets on the lift table 301 in the stacking unit 208 of the stacker 206 can be ejected out of the stacker 206 by the eject table 302, as indicated in FIG. 7B, for example.

On the other hand, in the case where the CPU 811 has determined that the state of the stacking unit 208 is the state illustrated in FIG. 7C, for example, in step S1301, it is determined that the ejecting operations can be carried out, and the processing advances to step S1303. In step S1303, the CPU 811 causes the state to transit from the state illustrated in FIG. 7C to the state illustrated in FIG. 7B by ejecting the eject table 302 of the stacker 206 to the exterior. This makes it possible to prevent the sheets printed through the current print job from mixing with the sheets printed through the previous job.

Next, the discharge processing 2 will be described with reference to FIG. 14.

FIG. 14 is a flowchart for describing the discharge processing 2 carried out in step S1103 of FIG. 11.

First, in step S1400, the CPU 811 resets the variable N, which indicates the number of copies being processed, to 1. Note that N is an integer greater than or equal to 1. The variable N is stored in the RAM 822. Next, the processing advances to step S1401, where the CPU 811 determines whether or not the variable N is less than or equal to a total number of copies (N_MAX). This processing ends in the case where the variable N is greater than N_MAX; however, in the case where the variable N is less than or equal to the total number of copies (N_MAX), it is determined that the printing processing is not complete for all of the copies, and the processing advances to step S1402. In step S1402, the CPU 811 resets the variable X, which indicates the number of copies being processed in the stacking of a designated number of copies, to 1. Note that X is an integer greater than or equal to 1 and less than N. Next, the processing advances to step S1403, where the CPU 811 determines whether or not the variable X is greater than a variable (X_MAX) indicating the number of copies in the stacking of a designated number of copies. In the case where the variable X is not greater than (X_MAX), the CPU 811 determines that the designated number of copies is not stacked, and advances the processing to step S1405. On the other hand, in the case where the CPU 811 determines in step S1403 that the variable X is greater than (X_MAX), the processing advances to step S1404. In step S1404, the stacking unit 208 of the stacker 206 is in a state in which a bundle of sheets corresponding to the designated number of copies (X_MAX) is stacked on the lift table 301, as illustrated in FIG. 6B. Accordingly, after that bundle of sheets is moved from the lift table 301 to the eject table 302, the CPU 811 causes the eject table 302 to be ejected out of the stacker 206 as indicated in FIG. 6C, after which the processing returns to step S1401.

Note that the total number of copies (N_MAX) is 10,000 in the example illustrated in FIG. 16, described earlier. Meanwhile, (X_MAX) is 1,000 in the example illustrated in FIG. 16 and described earlier, and both of these are stored in the RAM 822.

The processes of step S1405 to step S1411 are the same as the processes of step S1202 to step S1208 in the aforementioned FIG. 12, and thus descriptions thereof will not be given.

In the case where the CPU 811 has determined in step S1406 that the variable P is greater than the total number of pages (P_MAX), the processing advances to step S1412, where the CPU 811 adds 1 to the variable X indicating the number of copies in the stacking of a designated number of copies currently being carried out, adds 1 to the variable N indicating the number of copies being processed, and returns the processing to step S1403. Note that here, the total number of pages (P_MAX) corresponds to the total number of pages in the image data contained in the received print job, and is stored in the RAM 822.

According to the processing illustrated in FIG. 14, in the case where the stacking of a designated number of copies is set as illustrated in FIG. 16, for example, the process of step S1404 is executed each time bundles of sheets corresponding to 1,000 copies are stacked on the lift table 301. As a result, the operator can remove the bundles of sheets corresponding to the designated number of copies as a single bundle of sheets by removing the bundles of sheets corresponding to 1,000 copies that have been stacked on the eject table 302, from the eject table 302, and packaging those bundles. Note that in the example illustrated in FIG. 16, the operator can obtain all of the target bundles of sheets by removing the bundles of sheets corresponding to 1,000 copies, which are stacked on the eject table 302, ten times.

FIG. 15 is a flowchart for describing processing for discharging to the stacker 206 carried out in step S1207 of FIG. 12 and step S1410 of FIG. 14.

First, in step S1500, the CPU 811 determines whether or not it is possible to discharge to the stacking unit 208 of the stacker 206. At this time, the CPU 811 determines whether or not the stacking unit 208 is full based on a signal from a sensor of the stacking unit 208. In the case where the CPU 811 has determined in step S1500 that the stacking unit 208 is not full, the processing advances to step S1504, where the sheets printed by the MFP 102 are discharged to the stacker 206 and this processing ends.

On the other hand, in the case where it has been determined in step S1500 that the stacking unit 208 is full, the processing advances to step S1501, where the CPU 811 determines whether or not the stacked sheets can be ejected out of the stacker 206 by the eject table 302 of the stacking unit 208. When the ejecting is determined to be possible here, the processing advances to step S1503, where the CPU 811 causes the sheets stacked on the lift table 301 in the stacking unit 208 of the stacker 206 to be moved to the eject table 302, and ejects the eject table 302. As a result, sheets are no longer stacked on the lift table 301 of the stacking unit 208, and sheets received by the stacker 206 can therefore be stacked on the lift table 301. In this manner, the processing advances to step S1504, the sheets printed by the MFP 102 are discharged to the stacker 206, and this processing ends.

On the other hand, in the case where it is determined in step S1501 that the stacked sheets cannot be ejected out of the stacker 206 by the eject table 302, the processing advances to step S1502. In step S1502, the CPU 811 displays, on the display unit of the console unit 814, a message indicating that it is necessary to remove the sheets from the eject table 302 of the stacker 206, and then returns the processing to step S1501. In this case, upon the operator removing the sheets from the eject table 302, the sheets stacked on the lift table 301 are moved to the eject table 302, and the eject table 302 can then be ejected.

Although the foregoing embodiment describes a case where the MFP 102 serving as a printing apparatus and the stacker 206 serving as a sheet stacking apparatus are separate apparatuses, the present invention may also be applied in a printing apparatus in which the MFP 102 and the stacker 206 are integrated as a single apparatus.

### Other Embodiments

The embodiment of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of the above-described embodiment and/or that includes one or more circuits (e. g., application specific integrated circuit (ASIC)) for performing the functions of the above-described embodiment, and by a method performed by the computer of the system or apparatus by, for example, reading out and executing the computer executable instructions from the storage medium to perform the functions of the above-described embodiment and/or controlling the one or more circuits to perform the functions of the above-described embodiment. The computer may comprise one or more processors (e. g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-159767, filed Aug. 5, 2014, which is hereby incorporated by reference herein in its entirety.

What is claimed is:

1. A printing apparatus comprising:
a printing unit that prints onto sheets in accordance with a print job;
a stacking unit that receives the sheets printed by the printing unit and stacks the sheets, and that is able to eject the stacked sheets so that an operator can remove the sheets;
a determination unit that determines whether or not sheets are stacked on the stacking unit; and
a control unit that, when a setting for ejecting the stacked sheets each time a number of sheets corresponding to a designated number of copies have been stacked on the stacking unit is made for a print job and it is determined by the determination unit that sheets are stacked on the stacking unit, carries out control so that the sheets stacked on the stacking unit are ejected when execution of the print job starts.

2. The printing apparatus according to claim 1,
wherein the stacking unit includes:
a lift table that receives and stacks the sheets printed by the printing unit; and
an eject table that receives the sheets stacked on the lift table and ejects the sheets out of the printing apparatus.

3. The printing apparatus according to claim 2,
wherein after the sheets stacked on the lift table have been moved to the eject table, the lift table is in a state in which the lift table is able to receive and stack sheets printed by the printing unit.

4. The printing apparatus according to claim 2,
wherein when the eject table is ejected out of the printing apparatus and the sheets stacked on the eject table have been removed, the eject table returns to a state in which the eject table is able to receive sheets stacked on the lift table.

5. The printing apparatus according to claim 4, further comprising a notification unit that performs a predetermined notification, in the case where the setting is performed for the print job and it has been determined by the determination unit that sheets are stacked on the stacking unit and the sheets stacked on the stacking unit are in a state in which the stacked sheets cannot be ejected.

6. The printing apparatus according to claim 5,
wherein the state in which the stacked sheets cannot be ejected is a state in which sheets remain stacked on the eject table that has been ejected out of the printing apparatus.

7. The printing apparatus according to claim 1, further comprising a setting unit configured to make the setting.

8. A method for controlling a printing apparatus, the method comprising:
printing onto sheets in accordance with a print job;
receiving and stacking the sheets printed in the printing, and discharging and stacking the sheets printed in the printing on a stacker capable of ejecting the stacked sheets so that an operator can remove the sheets;
determining whether or not sheets are stacked in the stacker; and
carrying out control so that, when a setting for ejecting the stacked sheets each time a number of sheets corresponding to a designated number of copies have been stacked on the stacking unit is made for a print job and it is determined in the determining that sheets are stacked in the stacker, the sheets stacked in the stacker are ejected when execution of the print job starts.

9. A non-transitory computer-readable storage medium on which is stored a program for causing a computer to function as respective units of a printing apparatus comprising:
a printing unit that prints onto sheets in accordance with a print job;
a stacking unit that receives the sheets printed by the printing unit and stacks the sheets, and that is able to eject the stacked sheets so that an operator can remove the sheets;
a determination unit that determines whether or not sheets are stacked on the stacking unit; and
a control unit that, when a setting for ejecting the stacked sheets each time a number of sheets corresponding to a designated number of copies have been stacked on the stacking unit is made for a print job and it is determined by the determination unit that sheets are stacked on the stacking unit, carries out control so that the sheets stacked on the stacking unit are ejected when execution of the print job starts.
